(19) United States
(12) Patent Application Publication
(10) Pub. No.: US 2004/0116058 A1
(43) Pub. Date: Jun. 17, 2004

(54) Sub-aperture compliant toroidal polishing element

(75) Inventor: Stephen C. Meissner, West Henrietta, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/318,787

(22) Filed: Dec. 13, 2002

(51) Int. Cl. B24B 7/00; B24B 9/00; B24B 5/00; B24B 7/16; B23F 21/03; B23F 21/23; B24B 33/00

(52) U.S. Cl. 451/541; 451/178

(57) ABSTRACT

A precision sub-aperture polishing tool has a compliant, toroidal polishing member mountable to a support member. A circumferential portion of the polishing member extends uniformly beyond the peripheral surface of the support member and forms a clearance with the work piece surface during polishing operations.

### CROSS-REFERENCE TO RELATED APPLICATIONS

The present application is related to U.S. Application Serial Number ______, filed ______, by Stephen C. Meissner, and entitled, “Machine For Polishing The Surface Of A Work Piece;” U.S. application Ser. No. 10/241,144, filed Sep. 11, 2002, by Stephen C. Meissner, and entitled, “Dual Motion Polishing Tool.”

### FIELD OF THE INVENTION

The invention relates generally to the field of optical manufacturing processes, and in particular to polishing of optical surfaces. More specifically, the invention relates to a high-precision polishing tool for polishing an optical quality surface onto a substrate.

### BACKGROUND OF THE INVENTION

In manufacturing of optical components, lenses, molds and the like, preliminary operations, such as grinding or diamond turning, are performed to generate an optical surface on a raw blank of material. These preliminary operations provide the general form of the component, but leave surface defects that include turning grooves, cutter marks, and sub surface damage. A final polishing step is required to remove these surface and sub-surface defects. Polishing is typically accomplished in a variety of ways depending upon the material and the form of the surface, i.e., plano form, spherical form, or aspherical form.

Skilled artisans will appreciate that work piece surfaces having either a plano and spherical form are typically polished using “full-aperture” or “full-surface” tools. Full aperture tools tend to cover over 80% of the work piece surface during polishing. These tools are constructed in a variety of ways, including traditional “pitch” and more recent pad-type. “Pitch” polishing tools are comprised of a soft flow-able material, such as pitch or bees wax, which is used to create a mold of the optical surface.

Referring to FIG. 1, a typical prior art full aperture “pitch” polishing tool 10 has a plurality of grooves 12 to aid in the movement of polishing fluid at the interface of work piece surface (not shown). Polishing tool 10 has a support surface 14 attachable to a shank 16. Shank 16 defines an arbor for holding the polishing tool 10 for operation in a working unit. In operation, polishing tool 10 is held against the work piece (not shown) with an applied force and the two components, i.e., work piece and polishing tool 10, are moved relative to one another in the presence of a free abrasive polishing compound, such as cerium oxide, to achieve polishing.

Referring to FIG. 2, a typical full-aperture pad polishing tool 20 has of a pad mounting surface 22 for receiving a polishing pad 24 thereon. The polishing pad 24 is typically attached to the pad mounting surface 22 via an adhesive or via friction grip as disclosed in U.S. Pat. No. 4,274,232 issued to Wylde on Jun. 23, 1981, titled “Friction Grip Pad.”

Those skilled in the art will appreciate that polishing aspheric surfaces using full-aperture tools involves much iteration to rebuild or reshape the polishing tool slowing the polishing process considerably. Therefore polishing of aspheric surfaces is commonly restricted to sub-aperture methods using existing ring-tools or small-area tools. Sub-aperture methods using ring-tools or small-area tools rely on a polishing tool that contacts less than 50% of the work piece surface at one time. Ring tools, as disclosed in U.S. Pat. No. 4,768,308 issued to Leland G. Atkinson, III, et al. on Sep. 6, 1998, titled “Universal Lens Polishing Tool, Polishing Apparatus And Method Of Polishing,” have a diameter that is comparable to or larger than the radius of the work piece and contact the work piece surface over an area that is much larger than that for a small-area tool. Small-area tools contact only a small area of the work surface at a time and create an interfacial contact area that is on the order of 99% smaller than the area of the work piece surface.

Moreover, it is well known that sub-aperture small-area tools may be outfitted with a variety of polishing head shapes, including spherical (as shown in FIG. 3), but may also include conical, cylindrical, and flat along with a polishing pad. In FIG. 3, a sub-aperture tool 30 includes an arbor 32 fixedly attached to a spherical polishing head 34. It should be noted that the spherical polishing head 34 may be substituted with one of the aforementioned polishing heads of a different geometrical shape. Sub-aperture ring-tools may be considered a variation on the small-area tool with the polishing head being of ring-shaped configuration with surface contact during polishing being from 3% to 50% of the work piece surface.

It is further known that sub-aperture tools are commonly made from materials, such as felt, wood, cast iron, lead, and woven polymers, that allow free-abrasive particles to become imbedded within the material so that relative motion is generated between the abrasive particles and the part. Such materials allow free abrasive particles to imbed themselves within this carrier, allowing the tools to wear which is a detriment when trying to control material removal precisely. The concept of a compliant tool that does not allow free abrasive particles to imbed themselves and therefore is resistant to wear, provides advantage in precision polishing.

One precision polishing method, Elastic Emission Machining (EEM) uses this concept where a polishing tool (with a spherical or flat configuration) is made from an elastic solid. This tool is precisely controlled to maintain a minute gap between itself and the part surface within a temperature-controlled bath of free-abrasive slurry. The tool is rotated at high speed and is driven to traverse the part surface creating a hydrodynamic bearing at the tool-part interface gap. This situation allows abrasive particles to be projected against the surface being conditioned with sufficient energy to cause elastic penetration and subsequent precision material removal.

As with any method that uses a rotating tool, the area at the tool's center of rotation remains stationary—creating a “dead zone.” As the radial distance from the center of rotation increases, the tangential velocity also increases. Therefore, when polishing with sub-aperture tools, the greatest removal and subsequent benefit comes from a contact point radially distant from the tools center of rotation. For spherical or conical polishing tools, the tool must be tipped at an angle to provide needed tangential velocity. In order to generate productive velocities for polishing, spherical and conical polishing tools either need to be rotated at very high speeds or tipped at a large angle or a combination of the two. When very small tools are used, a combination of the two is required to gain maximum benefit.

Referring to FIGS. 4-7, limitations exist when attempting to polish deep concave surfaces, where a large angle would restrict the polishing capability of the tool. For example, using a tool with a spherical tip, an impractical angle of nearly 60 degrees would be required to achieve the same surface speed as a toroidal tip of the same overall diameter. FIG. 4 illustrates this example, where the arbor 32 of the spherical tipped tool interferes with the curved surface 40 of the part 42. Similar limitations exist for cylindrical and “flat” sub-aperture tools. As depicted in FIGS. 5, 6, and 7, cylindrical and “flat” sub-aperture tools 46 having arbor 32 and polishing surface 48 do not conform to curved surfaces 40 of the work piece or part 42 well and therefore restrict their application for polishing these surfaces. The cylindrical sub-aperture tool 46 allows minimum tilt while allowing maximum tangential velocity to be achieved, however, the contact area is crescent-like and tends to be non-uniform in this configuration, which is detrimental to precision polishing. If used without any tilt, benefits are realized from the maximized diameter, but fluid flow is restricted and the ability to polish severe or steep aspheres is limited.

Therefore, the need persists in the art for a precision polishing element for polishing optical surfaces without adversely affecting the quality of the surface.

### SUMMARY OF THE INVENTION

It is, therefore, an object of the invention to provide a precision polishing tool capable of uniformly polishing optical surfaces.

Another object of the invention is to provide a sub-aperture tool that minimizes tilt limitations and conforms to the surface of the work piece to be polished.

The present invention is directed to overcoming one or more of the problems set forth above. Briefly summarized, according to one aspect of the present invention, a precision polishing element for polishing a work piece surface has a compliant, toroidal polishing member mountable to a support member. The compliant, toroidal polishing member has an active polishing surface extended uniformly beyond a peripheral surface of the support member for engaging the work piece surface.

The tool disclosed provides greater advantage for free-abrasive type polishing operations, like EEM, due to the toroidal geometry. The toroidal shape allows shallow contact angles to be used, providing significant practical advantage for polishing steep concave surfaces. The toroidal shape is also advantageous due to the low axial profile, while providing radial distance to maximize tangential speed for material removal. The shape of the toroid also provides a uniform geometry that allows for polishing fluid to be transported along the circumference, providing the necessary flow required for polishing. In addition, the contact area generated at the tool-part interface tends to be very uniform and consistent, appearing oval in shape, which is essential for deterministic polishing.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an isometric view of a prior art polishing tool;

FIG. 2 is an isometric view of a prior art polishing tool with a polishing pad;

FIG. 3 is an isometric view of a prior art sub-aperture polishing tool with a spherical polishing head;

FIG. 4 shows the interference condition when a spherical sub-aperture polishing tool used in prior art, angled at nearly 60 degrees from vertical to achieve satisfactory surface speed for productive material removal, engages a concave surface;

FIG. 5 shows a sub-aperture pitch/pad polishing tool used in prior art, engaged with a concave surface;

FIG. 6 shows a sub-aperture pitch/pad polishing tool used in prior art, engaged with a convex surface;

FIG. 7 shows a sub-aperture cylindrical polishing tool used in prior art, engaged with a convex surface;

FIG. 8 illustrates the first example of the embodiment of the compliant toroidal polishing tool according to the invention;

FIG. 9 is a close up view of the toroidal polishing tip of the compliant toroidal polishing tool according to the invention;

FIG. 10 illustrates the second example of the embodiment of the polishing tool according to the invention;

FIG. 11 is an exploded view of the third example of the embodiment of the polishing tool according to the invention;

FIG. 12 is an exploded view of the fourth example of the embodiment of the polishing tool according to the invention;

FIG. 13 is a close up view of the compliant toroidal tip;

FIG. 14 is a cross-sectional view of the polishing tip showing a circular cross section of the compliant toroidal tip;

FIG. 15 is a cross-sectional view of the polishing tip showing an oval cross-section of the compliant toroidal tip with the long side of the oval aligned perpendicular to the arbor axis;

FIG. 16 is a cross-sectional view of the polishing tip showing an oval cross-section of the compliant toroidal tip with the long side of the oval aligned parallel to the arbor axis;

FIG. 17 is a cross-sectional view of the polishing tip showing a square cross-section with rounded corners of the compliant toroidal tip;

FIG. 18A illustrates a typical clearance condition when a compliant toroidal polishing tool is used in service; and

FIG. 18B illustrates the polishing tool of the invention in contact with the work piece.

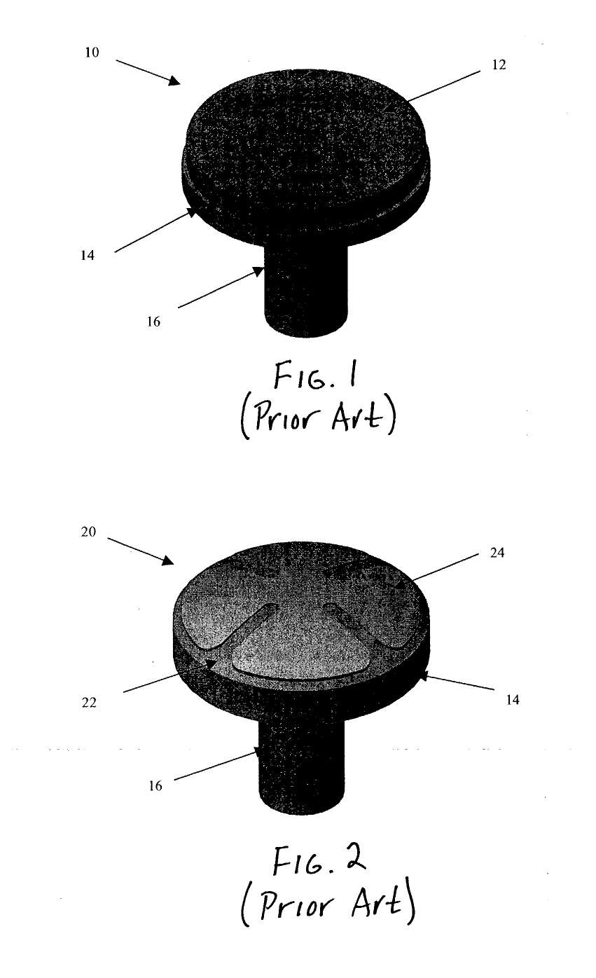

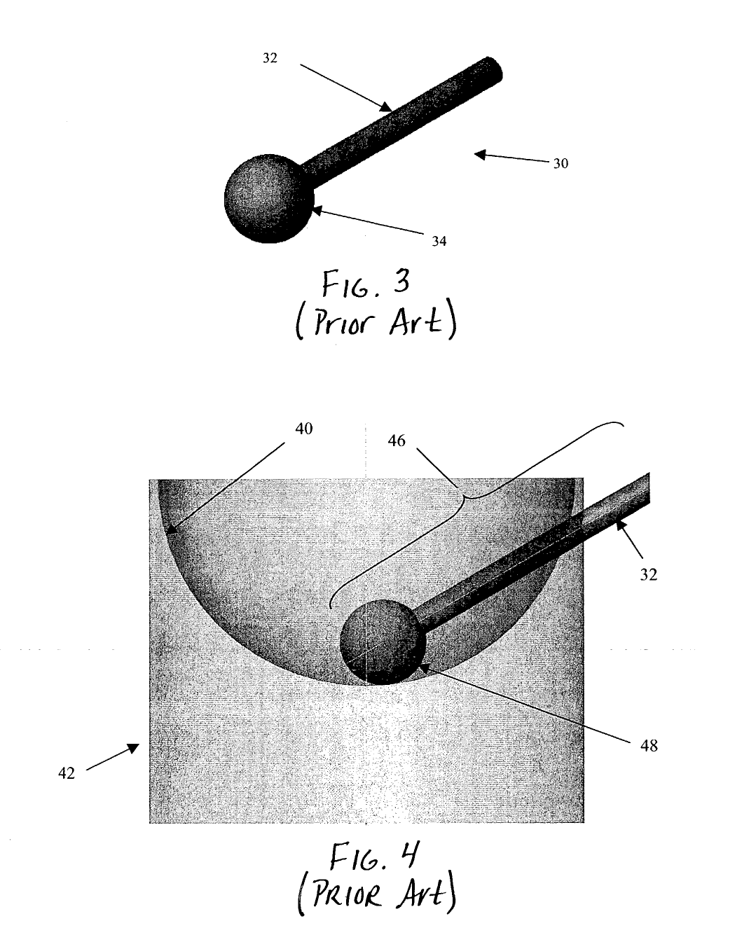

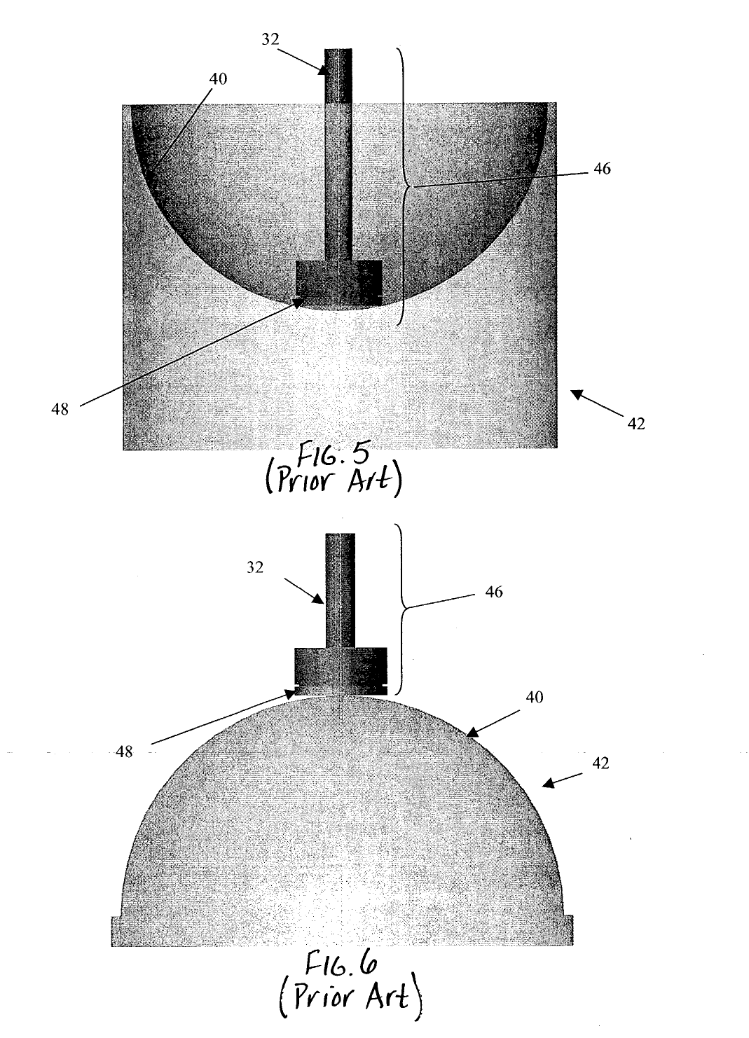

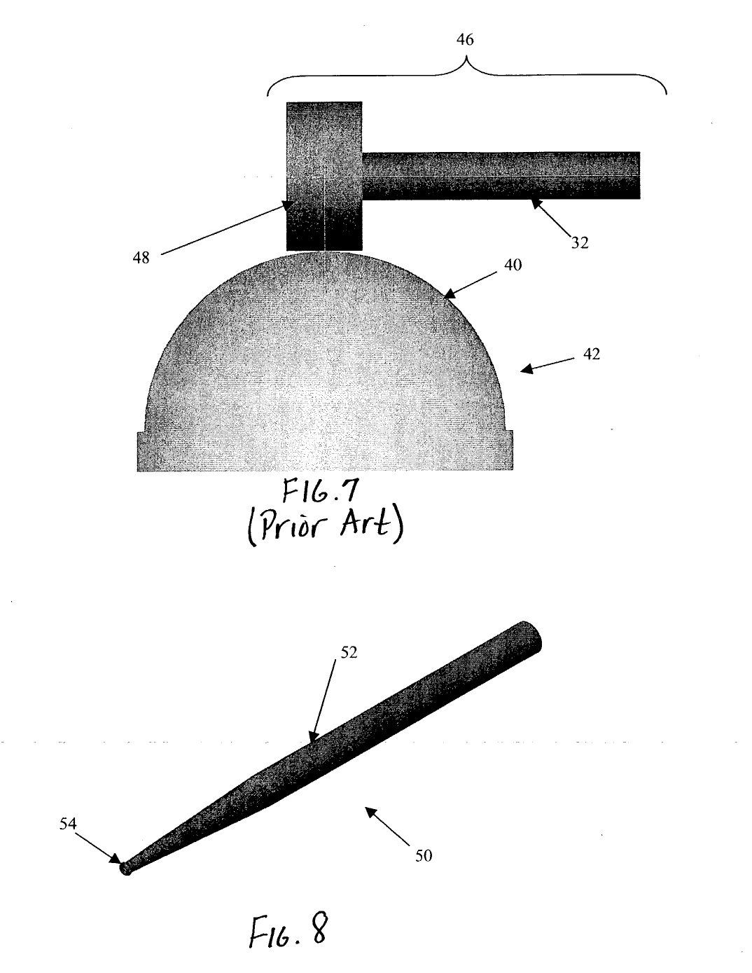

### DETAILED DESCRIPTION OF THE INVENTION

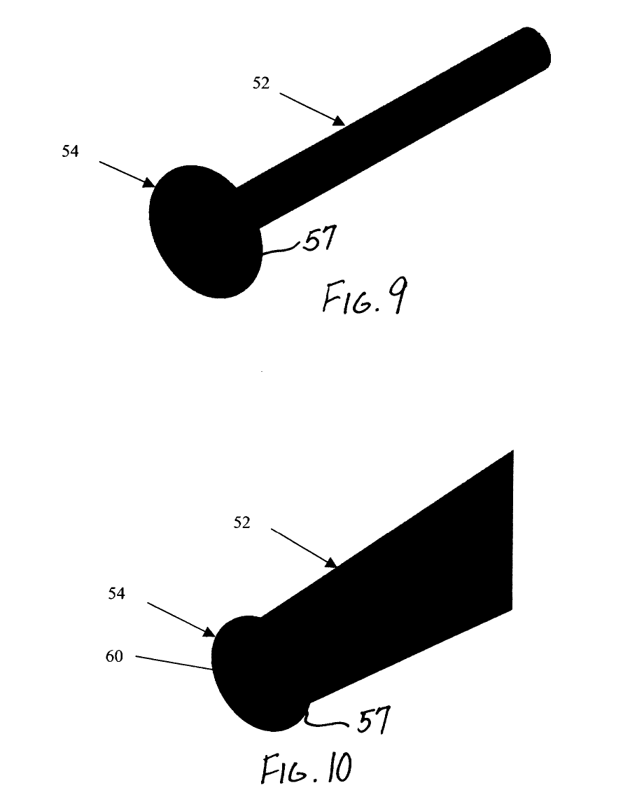

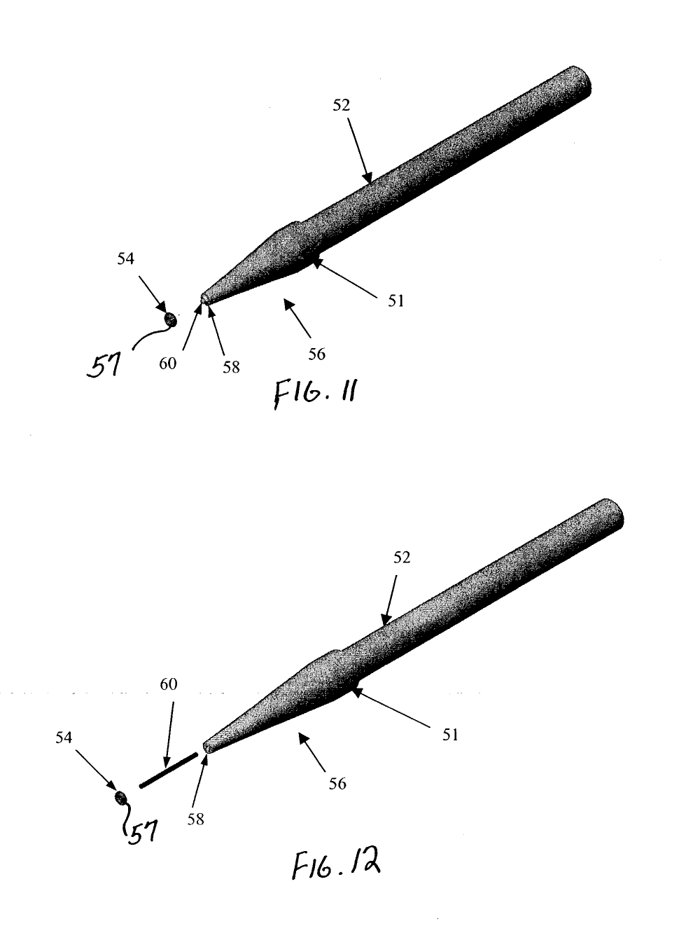

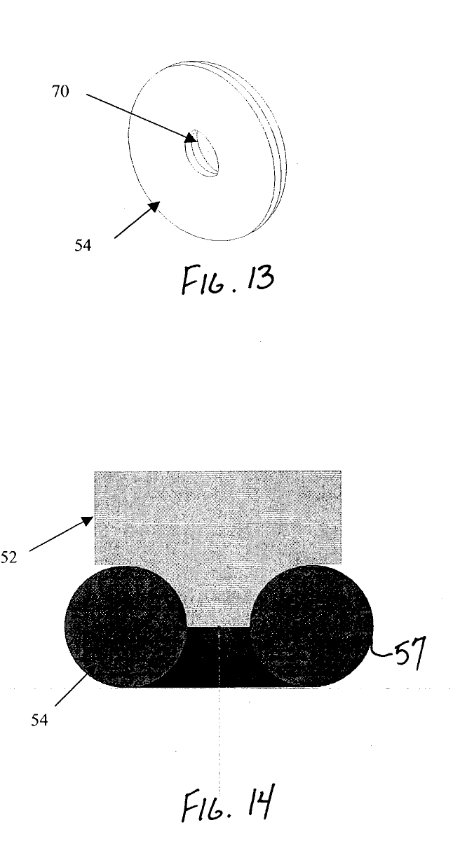

Turning now to the drawings, and in particular to FIGS. 8-13, the compliant toroidal polishing element 50 of the invention is illustrated. Broadly defined, compliant toroidal polishing element 50 includes a support member, or mounting arbor 52, and a compliant toroidal polishing tip 54 mounted to the mounting arbor 52. Compliant toroidal polishing tip 54 preferably has a circumferential active polishing surface 57 extending substantially symmetrically beyond the peripheral surface of the mounting arbor 52 for engaging the curved surface 40 of work piece 42. Work piece 42 may comprise a variety of materials including metallic materials, ceramic materials, and vitreous materials. According to FIGS. 9-12, the mounting arbor 52 may be constructed simply as a solid (as shown) or hollow cylinder. Referring to FIG. 11, the mounting arbor 52 is preferably constructed with additional features, such as a locating shoulder 51 for advantage in tool holding and repetitive placement. Mounting arbor 52 has a distal end 56 with support surface 58 for supporting compliant toroidal polishing tip 54. Upon support surface 58, a centering boss 60 may be mounted which aids in providing concentric alignment of toroidal polishing tip 54 during attachment. If provided, centering boss 60 projects normally from support surface 58 of distal end 56. Toroidal polishing tip 54 of toroidal geometry is then attached centrally to the support surface 58, whereby the toroidal polishing tip 54 is concentric with the diameter of the mounting arbor 52. According to FIG. 13, the toroidal polishing tip 54 may have an alignment port 70 concentric with its outside diameter intended to mate with centering boss 60 (FIG. 12) if provided on mounting arbor 52 to provide concentric alignment and to aid in attachment.

Attachment of the toroidal polishing tip 54 to the arbor 52 may be accomplished in a variety of ways including adhesive, chemical, thermal, or mechanical bonding. Once joined, the compliant toroidal polishing tool 50 of the invention is ready for use.

Referring again to FIGS. 9 and 10, an important feature of compliant toroidal polishing element 50 is the compliant toroidal tip 54. The compliant toroidal tip 54 may be manufactured from a variety of compliant polymers such as, but not limited to, polyurethane, chloroprene, fluorocarbon, fluorosilicone, ethylene propylene, and nitrile. We prefer using nitrile because of its compliant properties. For advantageous sub-aperture deterministic polishing in the presence of free-abrasive lapping compound, the hardness of the compliant toroidal polishing tip 54 needs to be in the range of 40-95 on the Shore A scale.

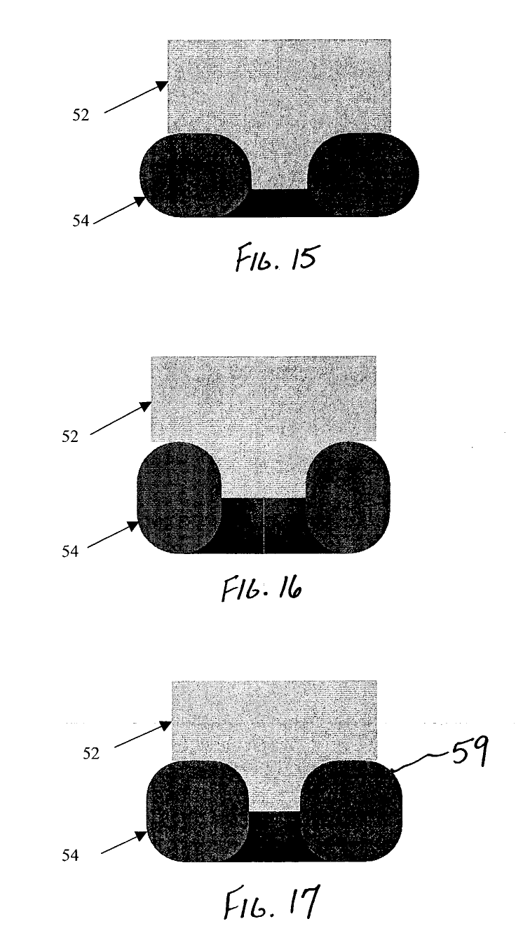

Referring to FIGS. 14-17, the shape of toroidal polishing tip 54 may deviate from a pure toroid and still provide advantage in polishing. According to FIG. 14, toroidal tip 54 has a substantially circular shape. According to FIG. 15, toroidal tip 54 has a substantially horizontally oriented oval shape. According to FIG. 16, toroidal tip 54 has a substantially vertically oval shape. According to FIG. 17, toroidal tip 54 has a substantially square shape with rounded corners 59. If used, centering boss 60 should be made so arbor material does not extend beyond the boundary of the toroidal polishing tip 54 to avoid risk of damage to part surface when polishing.

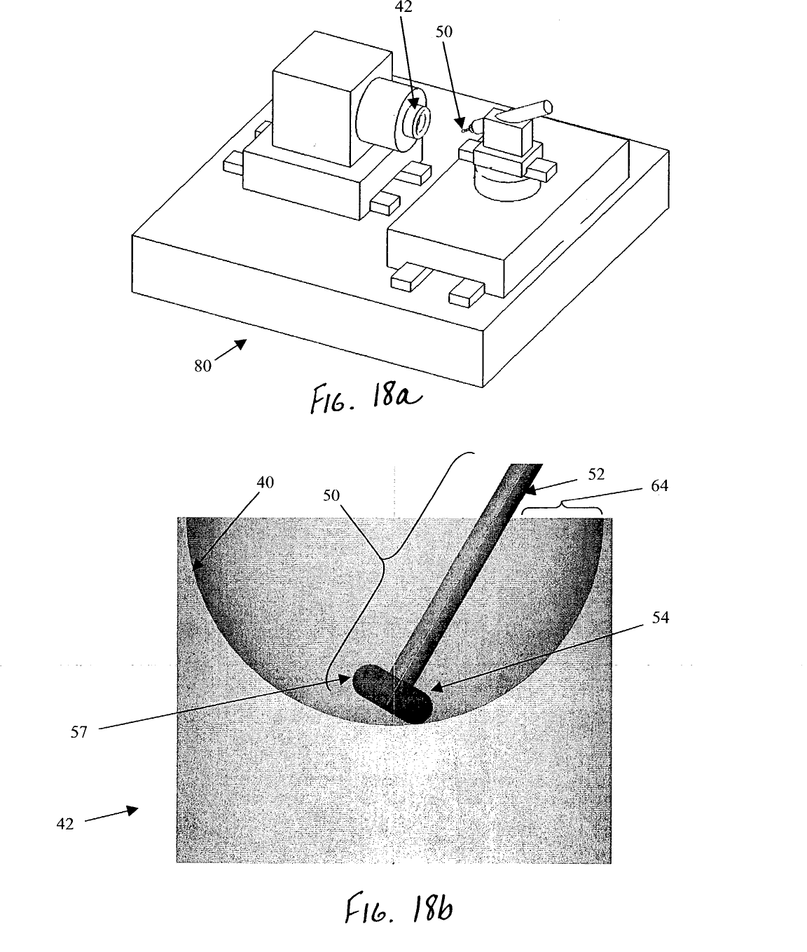

According to FIG. 18A, in operations, compliant toroidal polishing element 50 is mounted in a rotary polishing machine 80 for polishing a work piece. As shown in FIG. 18B, the polishing surface 57 engages curved surface 40 of work piece 42 for polishing. An important advantage of compliant toroidal polishing element 50 is that a clearance 64 is formed between the mounting arbor 52 and the curved surface 40 of the work piece 42. Experience suggests that compliant toroidal polishing element 50 should be angled at about 30 degrees from a centerline extending normally through the curved surface 40 for most efficient operation. According to our experience, this arrangement produces satisfactory surface speed for productive material removal during polishing.

The invention has been described with reference to a preferred embodiment. However, it will be appreciated that variations and modifications can be effected by a person of ordinary skill in the art without departing from the scope of the invention.

### Parts List

10 full-aperture pitch polishing tool

12 grooves

14 support surface

16 shank

20 full-aperture pad polishing tool

22 pad mounting surface

24 polishing pad

30 sub-aperture tool

32 arbor

34 spherical polishing head

40 curved surface

42 work piece

46 sub-aperture tool

48 polishing surface

50 compliant toroidal polishing element

51 locating shoulder

52 mounting arbor

54 polishing tip

56 distal end

57 polishing surface

58 support surface

59 rounded corners

60 centering boss

64 clearance

70 alignment port

80 rotary polishing machine

What is claimed is:

1. A precision polishing element for polishing a work piece surface, comprising:
a compliant, toroidal polishing member mountable to a support member, said compliant, toroidal polishing member having a circumferential active polishing surface extending beyond a peripheral surface of said support member for engaging the work piece surface.

2. The precision polishing element recited in claim 1 wherein said active polishing surface is concentric with an interior mounting surface of said compliant, toroidal polishing member, said interior mounting surface being mountable on an extended portion of said support member.

3. The precision polishing element recited in claim 1 wherein said compliant, toroidal polishing member comprises a material selected from the group consisting of an elastic solid material, a polymeric material, and a mixture thereof.

4. The precision polishing element recited in claim 3 wherein said polymeric material is selected from the group consisting of: polyurethane, chloroprene, fluorocarbon, fluorosilicone, ethylene propylene, and nitrile.

5. The precision polishing element recited in claim 4 wherein said polymeric material is nitrile.

6. The precision polishing element recited in claim 2 wherein said active polishing surface of said toroidal, polishing member is at least partially conformable with a surface of said work piece being polished.

7. The precision polishing element recited in claim 1 wherein said support member is mounted to said compliant, toroidal polishing member with an adhesive bonding material.

8. The precision polishing element recited in claim 1 wherein said support member is mounted to said compliant, toroidal polishing member by chemical bonding.

9. The precision polishing element recited in claim 1 wherein said support member is mounted to said compliant, toroidal polishing member by thermal bonding.

10. The precision polishing element recited in claim 1 wherein said support member is mounted to said compliant, toroidal polishing member by mechanical bonding.

11. The precision polishing element recited in claim 2 wherein said active polishing surface has a Shore A hardness in the range of about 40-95.

12. The precision polishing element recited in claim 1 wherein said compliant, toroidal polishing member has a substantially elongated shape along a radial axis.

13. The precision polishing element recited in claim 1 wherein said compliant, toroidal polishing member has a substantially elongated shape along an axial axis.

14. The precision polishing element recited in claim 1 wherein said compliant, toroidal polishing member has a substantially square shape with rounded end edge portions.

15. The precision polishing element recited in claim 1 wherein said work piece surface is an optical surface.

16. The precision polishing element recited in claim 1 wherein said work piece surface is ceramic.

17. The precision polishing element recited in claim 1 wherein said work piece surface is a vitreous material.

18. The precision polishing element recited in claim 1 wherein said work piece surface is a metal.
